(19) United States
(12) Patent Application Publication
(10) Pub. No.: US 2025/0042044 A1
(43) Pub. Date: Feb. 6, 2025

(54) SAPLING GRIPPING HEAD

(71) Applicant: Deere & Company, Moline, IL (US)

(72) Inventors: VISHAL PURANIK, Osmanabad (IN); SYED GOUSE MOIDDIN, Hyderabad (IN); RITESH KONDEKAR, Pune (IN); RICHARD J. LAWLER, St. Augustine, FL (US)

(21) Appl. No.: 18/602,111

(22) Filed: Mar. 12, 2024

(30) Foreign Application Priority Data
Aug. 5, 2023 (IN) 202321052734

(51) Int. Cl. B25J 15/02; A01C 11/00; B25J 15/00

(52) U.S. Cl. CPC B25J 15/0293; A01C 11/006; B25J 15/0052

(57) ABSTRACT

A sapling gripping head for a transplanter. The sapling gripping head is attached to sapling retrieval apparatus and comprises a support frame and a sliding frame, slidably coupled to each other. A plurality of gripping units are placed along the length of the gripping head. Each of the gripping units comprises of a first fork and a second fork. An actuation mechanism is provided to actuate the gripping head. Each of the first forks is attached to the support frame and each of the second forks is attached to the sliding frame. The sliding frame is configured to slide relative to the support frame via the actuation mechanism.

### CROSS-REFERENCE TO RELATED APPLICATIONS

This application claims priority under 35 U.S.C. § 119 to patent application IN 202321052734, filed on May 8, 2023, the disclosure of which is incorporated herein by reference.

### FIELD OF THE DISCLOSURE

The present disclosure relates to silviculture and more specifically a sapling gripping head of a transplanter for forests.

### BACKGROUND OF THE DISCLOSURE

The silviculture process can be slow, cumbersome, and may require careful handling because the process involves planting fragile saplings into the ground. Furthermore, precision in planting depth, subsequent watering, fertilization, water retention around the sapling, and adequate spacing between saplings are some of many variables adding to the complexity to optimize the survival rates and growth of saplings once planted. Saplings can generally be sensitive to environmental conditions, handling, and conditions of planting. Generally done by hand, therein lies a need for an automated or semi-automated process to efficiently and carefully plant a multitude of saplings into the ground to support reforestation efforts.

An automated or semi-automated planting process may aim to plant a maximum number of saplings with high-speed and precision planting operation considering time duration, economy, cost factor, and an availability of manpower, etc. As a part of high-speed and precision planting, the planter vehicle or transplanter needs to store a large volume of saplings which are brought from the nursery to the planting field. The thousands of saplings typically come in multiple sapling trays. The sapling trays need to be stored and conveyed/transferred to the planting unit (which plants the saplings) in such a manner as not to affect the sapling quality and life. To fulfill such a requirement the planting vehicle or the transplanter needs to have a sapling gripping head to pick the row of saplings from the tray with precision and accuracy at the high operating speeds. Hence, there a need for a new sapling gripping head which obviates the problems of the currently available sapling gripping heads.

The present disclosure envisages achieving at least one of the following objects including providing a sapling gripping head for a transplanter which can pick a row of saplings from the sapling tray and release the sapling to the sapling indexing unit. Another object of the present disclosure is to provide an actuation mechanism for the sapling gripping head and operating a plurality of gripping units via a single actuator. Yet another object of the present disclosure is to optimize the operation of gripping head.

Other objects of the present disclosure will be apparent when the description of the disclosure is read in conjunction with the accompanying drawings. The accompanying drawings provided herein are merely illustrative and are not intended to limit the scope and ambit of the present disclosure.

### SUMMARY OF THE DISCLOSURE

In accordance with the present disclosure a sapling gripping head is provided for a transplanter. The sapling gripping head comprises a support frame and a sliding frame, slidably connected to each other. A plurality of gripping units are placed along the length of the gripping head and each of the gripping units comprises of a first fork and a second fork. Each of the first forks is attached to the support frame. Each of the second forks is attached to the sliding frame and the sliding frame is configured to slide relative to the support frame via an actuation mechanism. The actuation mechanism further comprises a biasing member that biases the sliding frame against the support frame and the actuation mechanism slides the sliding frame against the force of biasing member. Each of the first forks comprises a pair of fingers and the pair of fingers may form a ‘v’ shape. A gap is formed between the first fork and the second fork of a gripping unit and is configured to hold the sapling. The actuation mechanism may be a linear solenoid actuator and a controller and is configured to regulate the actuation mechanism.

The present disclosure has several technical advancements, including but not limited to the realization of a firm gripping of saplings within a sapling gripping head, operating the gripping unit with a linear actuator and gripping multiple saplings by a single actuator.

While the foregoing specification has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure which comes within known or customary practice in the art to which this disclosure pertains.

Other features and aspects will become apparent by consideration of the detailed description and accompanying drawings.

### BRIEF DESCRIPTION OF THE DRAWINGS

FIG. 1 illustrates a work machine with a transplanter coupled at a rear end;

FIG. 2 illustrates a perspective view of the sapling tray handling system attached to the transplanter frame;

FIG. 3 illustrates a sapling tray partially filled with saplings;

FIG. 4 illustrates the sapling gripping head attached to a sapling retrieval apparatus;

FIG. 5 illustrates a support frame of a sapling gripping head;

FIG. 6 illustrates a slidable frame of a sapling gripping head;

FIG. 7 illustrates forward perspective view of the sapling gripping head;

FIG. 8 illustrates rear perspective view of the sapling gripping head;

FIG. 9 illustrates plane view of sapling gripping head in an open condition;

FIG. 10 illustrates plane view of sapling gripping head in a closed condition;

FIG. 11 illustrates a forward perspective view of a sapling gripping head along with a sapling; and

FIG. 12 illustrates a flow chart explaining the operation of the sapling gripping head.

Before any embodiments are explained in detail, it is to be understood that the disclosure is not limited in its application to the details of construction and the system of components set forth in the following description or illustrated in the following drawings. The disclosure is capable of other embodiments and of being practiced or of being carried out in various ways. Further embodiments of the disclosure may include any combination of features from one or more dependent claims, and such features may be incorporated, collectively or separately, into any independent claim.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term “controller” is a computing device including a processor and a memory. The “controller” may be a single device or alternatively multiple devices.

As used herein, the term “module” refers to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

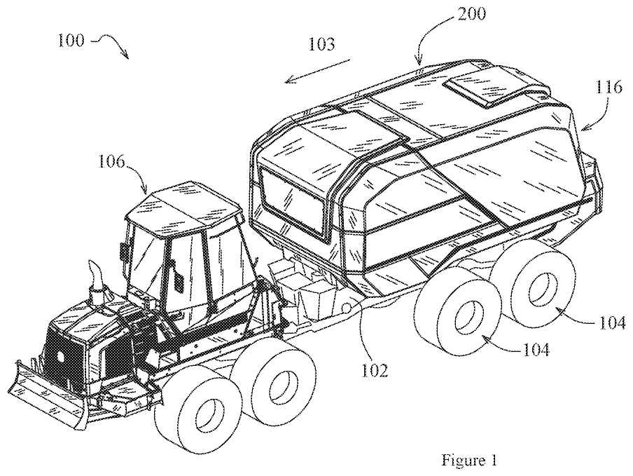

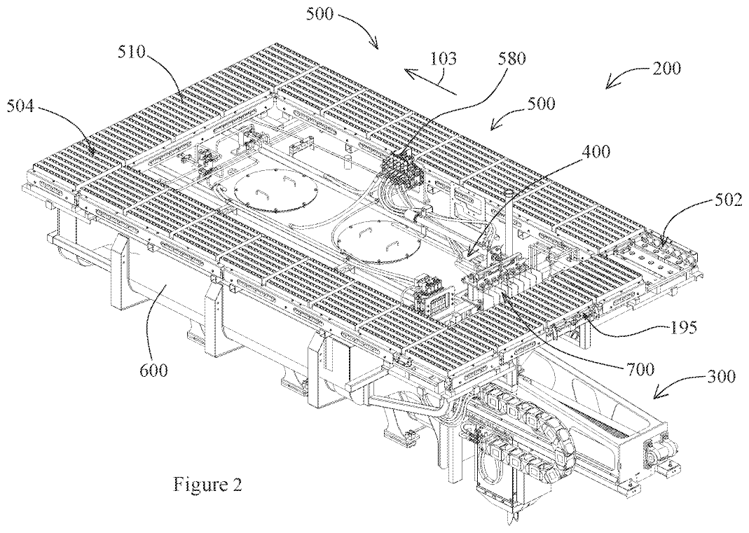

FIG. 1 illustrates a perspective view of a work machine 100 comprising a sapling transplanter 200. A sapling planting apparatus 300 (shown in FIG. 2) attached at rear end of the sapling transplanter 200, according to one embodiment. It is intended that the sapling planting apparatus 300 provides for continuous sapling planting while the work machine 100 continues to advance as the sapling planting apparatus 300 plants the sapling into the ground, thereby advantageously reducing fuel consumption and increasing efficiency by minimizing a stop/start of the work machine 100 when planting. An alternative embodiment may comprise a sapling transplanter 200 coupled to a work machine 100, such as a tractor, rather than a singular piece of equipment. Therein, the term work machine 100 may include a transplanter 200 on a work machine 100, or a work machine 100 towing a sapling transplanter 200. Note the sapling planting apparatus 300 is one of several subcomponents found within the planter vehicle or work machine 100. Furthermore, the terms “work machine,” “planter vehicle” and “transplanter” may be used interchangeably throughout this disclosure.

The planter vehicle or work machine 100 may comprise one or more subcomponents and/or subsystems described herein to automate or semi-automate the sapling planting process. The present disclosure includes a planting vehicle or work machine 100 with multiple subsystems. However, used holistically or in part, these subsystems provide an improved process for planting multiple saplings through the automated or a semi-automated process. The work machine 100 may include a chassis 102, ground-engaging supports 104, such as wheels, and a propulsion system (not shown). The propulsion system, such as a diesel engine or motor, or an electric engine provides for motive power driving the wheels and for operating the other components associated with the planter vehicle or work machine 100 such as actuators. The operator cab 106, or alternatively a remote operating station (not shown) where an operator sits when operating the work machine 100, includes a user input interface with a plurality of controls (e.g. switches, joysticks, pedals, buttons, levers, display screens, etc.) for controlling the planter vehicle or work machine 100 during operation thereof.

As depicted in FIGS. 1 and 2, the forward portion or direction 103 of the planter vehicle or work machine 100 is generally to the left and the rearward portion or direction of the planter vehicle or work machine 100 is generally to the right. The planter vehicle or work machine 100 may include a sapling retrieval apparatus 400 (shown in the FIG. 2) which retrieves saplings from a sapling tray handling system 500 and feeds saplings into the sapling planting unit 300. The planter vehicle or work machine 100 may further include an external housing 116, which generally shields various subcomponents of the planter vehicle or work machine 100 from dust, debris, winds, rain, and other harsh environmental conditions. The primary subcomponents and subsystems may include the sapling tray handling system 500, the sapling retrieval apparatus 400, the sapling planting unit 300, the sapling hydrating module 600 (which includes the water tank), and a sapling transfer and indexing system 700.

A controller 180 may have one or more microprocessor-based electronic control units or controllers which perform calculations and comparisons and execute instructions. The controller 180 may also include a processor, a core, volatile and non-volatile memory, digital and analog inputs, and digital and analog outputs. The controller 180 may connect to and communicate with various input and output devices including, but not limited to, switches, relays, solenoids, actuators, light emitting diodes (LED's), liquid crystal displays (LCD's) and other types of displays, radio frequency devices (RFD's), sensors, and other controllers. The controller 180 may receive communication or signals, via electrically or any suitable electromagnetic communication, from one or more devices, determine an appropriate response or action, and send communication or signals to one or more devices. The controller 180 can be a programmable logic controller, also known as a PLC or programmable controller. The controller 180 may couple to a separate work machine electronic control system through a data bus, such as a CAN bus, or the controller 180 can be a part of the work machine electronic control system.

The controller 180 may be in communication with one or more devices including, but not limited to, a vehicle speed sensor to receive information about the vehicle speed, position/proximity sensors to receive various positional inputs about the sapling stock as it moves through the planter vehicle or work machine 100, geolocation sensors to receive information about the planter vehicle's location, obstruction detector sensors, the pump and/or pump controller to provide commands or instructions and/or receive information about direction and flow of hydrating fluid to and from the hydrating fluid storage tank, visual inputs from cameras, and the user input interface to receive commands or instructions and provide feedback. The controller 180 may receive communication from and provide communications, controls, or instructions to any of these devices and any of the subcomponents. This list is not all-inclusive and is detailed further below.

The planting vehicle or work machine 100 may move across a field and retrieve one or more saplings 518 (e.g., a eucalyptus tree) from its sapling tray handling unit 500. The planting vehicle or work machine 100 may then plant a sapling 518 into the ground, while watering and or fertilizing the sapling 518. Note that the while the present embodiment demonstrates planting of a single sapling 518 at any given moment, the mechanism can be configured to plant two or more saplings 518 at any given moment. The sapling tray handling system 500 comprises a rectangular loop track 502 to support a multitude of trays 504, the trays 504 collectively have the capacity to hold thousands of saplings 518. The sapling tray handling system 500 comprises a rectangular loop track thereby minimizing the footprint traversing the ground, while maximizing storage capacity of the sapling tray handling system 500 by transferring the plurality of trays within the track on the horizontal plane. A sapling hydrating module 600 is found below the rectangular track to optimize usage of space. Furthermore, the smaller footprint allows for ease of transportation along industry standard roadways when transporting the planter vehicle or work machine 100 from a first location to a second location.

The saplings 518 are grouped in trays 510. The sapling tray handling system 500 is configured to convey the trays 510 holding rows of saplings 520 towards the sapling retrieval apparatus 400 (shown in FIG. 2) and indexes to a next tray 510 as each tray 510 is emptied by the sapling retrieval apparatus 400. Trays 510 are replaced by an operator in an access area 195, wherein the operator may reload the sapling tray handling system 500 with a new set of filled trays 510. The trays 510 are removably placed for sliding engagement on roller frames 538 in the track of the sapling tray handling system 500. In an embodiment as shown in FIG. 2, the access area 195 is the same as the pickup area defined by the placement of the sapling retrieval apparatus 400. The pickup area is where the sapling retrieval apparatus 400 may access the saplings 518. The controller 180 is programmed to control operation of the sapling tray handling system 500, wherein the controller 180 actuates a drive mechanism 580 upon receipt of proximity sensor input signals. A plurality of tags including information distinguishing each individual sapling 510 (e.g., an identification code), row of saplings, or tray of saplings from others may be attached to trays 510, wherein the controller 180 is programmed to record information from a tag reader and process the information as the sapling 518 is planted, thereby correlating the identification code with a geolocation of the sapling 518. This information may be aggregated in memory, thereby mapping productivity as it occurs. In one embodiment, the information can be visually displayed on a user input interface (not shown) as the planter vehicle or work machine 100 progresses, or after completion of a sapling lot.

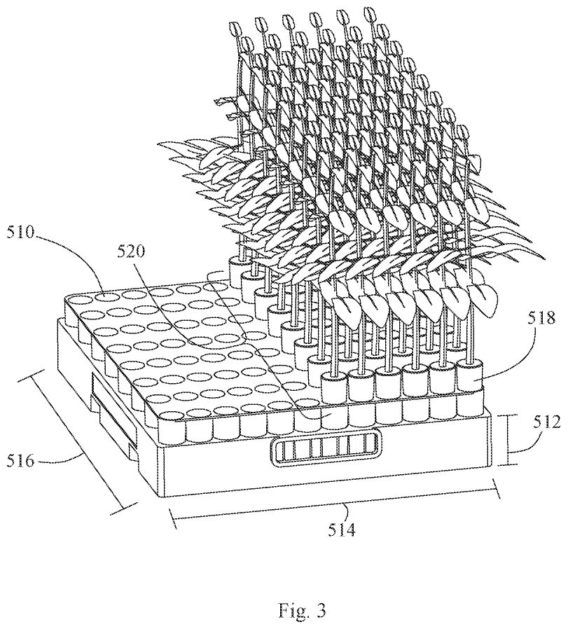

In an embodiment, as shown in FIG. 3, each sapling tray 510 may carry plurality of saplings 518 in multiple rows 520. Each tray 510 may carry eight rows and thirteen columns of saplings 518 and thus may accommodate one hundred and four saplings 518. The overall dimensions of the tray including width 516, length 514, and height 512 are optimized to fit into the track 502. In an embodiment, the width 516 and length 514 of the tray are approximately equal such that the tray 510 traverses the track 502 efficiently. As shown in FIG. 2, the sapling tray handling system 500 may accommodate the plurality of sapling trays 510 preferably twenty-three trays and thus may handle 2392 saplings 518. However, the above numbers are not limiting and may vary according to design and size of the transplanter 200. Further, the track 502 is fixed above the water tank of the hydrating module 600. In an embodiment, the sapling retrieval apparatus 400 is placed beside the track 502, proximal to the sapling planting unit 300 and a sapling transfer and indexing system 700 is placed between the two to convey the saplings from the sapling retrieval apparatus 400 to the planting unit 300.

FIG. 2 further shows tray access area 195. The access area 195 allows an operator to unload empty trays 510 and load trays 510 with saplings 518. In a closed state, the gate 560 works like a roller frame and allow smooth movement of the sapling tray 510 and holds the tray 510 when trays 510 are not moving. The gate 560 has as latch 564 with a spring mechanism to keep gate 560 in the closed position during normal operation. The access area 195 further has a base plate 546 to support the sapling tray 510 during the sapling pickup by sapling retrieval apparatus 400 and loading or unloading of trays. During loading operation, the operator unlocks the latch 564 and opens the gate 560. Once the gate 560 is open, the operator may remove the trays 510 and add trays 510. In an embodiment, to assist the operator in loading the trays 510, the controller 180 may actuate the four actuators positioned at corners and move the trays 510 as the operator add or remove the trays 510 from the loading area 195. During loading operation, it is contemplated that the controller 180 may operate the actuators automatically by sensing the position of trays 510 or receive input from the operator to move the trays 510. In an additional embodiment, the operator may move the trays 510 manually during the unloading or loading of saplings trays 510.

In an embodiment, the predetermined sequence is stored in memory of the controller 180. It is contemplated that multiple sequences are stored in the memory. An operator may select any preferred sequence or may edit the sequence using the display on operator station. The controller 180 through the sensing module may identify the full trays 510, empty trays 510 and partially filled trays 510 and is configured to operate a partial cycle until all trays 510 are empty or based on the operator input on when to stop the cycle.

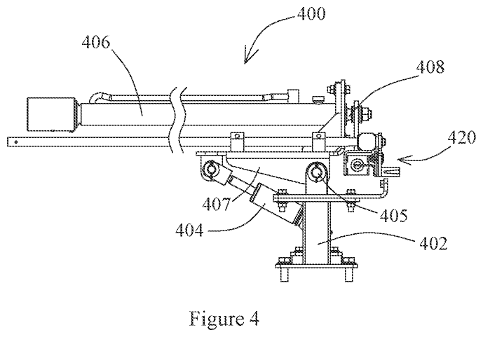

FIG. 4 illustrates the sapling retrieval apparatus 400. The sapling retrieval apparatus 400 has a base 402 fixedly attached to the top of water tank of the hydrating module 600. A platform 407 is pivotably connected to the base 402 at pivot 405. The platform 407 is pivoted via a first actuator 404. A second actuator 406 is coupled to the pivotable platform 407 and is configured to the extend and retract in the direction of vehicle 103 and more preferably towards the sapling trays 510. As shown, a sapling gripping head 420 is coupled to the rod end of the second actuator 406 via a top bracket 408. In operation, the first actuator 404 pivots the pivotable platform 407 and controls the height of the sapling gripping head 420, and the second actuator moves the sapling gripping head 420 towards or away from the sapling tray 510. In an embodiment, considering various inputs form the sensing module 190 such as the vehicle speed, position of tray 510, number of saplings 518 in tray 510 placed at pickup area, number of vacant rows, and number of occupied rows the controller 180 control the first actuator 402 and second actuator to control the position of the sapling gripping head 420 with respect to the sapling tray 510 which was secured in pickup area 402.

The primary functions of the gripping head 420 include holding the plurality of saplings 518 in a row 520 from the sapling tray 510, lift, carry and drop the saplings 518 to indexing system 700. The first actuator 404 and the second actuator 406 operate the position of the gripping head 420 with respect to the sapling tray 510 and sapling transfer and indexing module 700.

A support frame 422 is illustrated in FIG. 5. The support frame 422 is attached to the second actuator 406 through the bracket 408 (shown in FIG. 4). The support frame 422 comprises a plurality of holes 432 to receive fasteners 430, a plurality of first forks 434, a plurality of slots 435 proximal to the first forks 434 and a case 440 fixedly coupled to the bracket 408 and further carries an actuation mechanism 438.

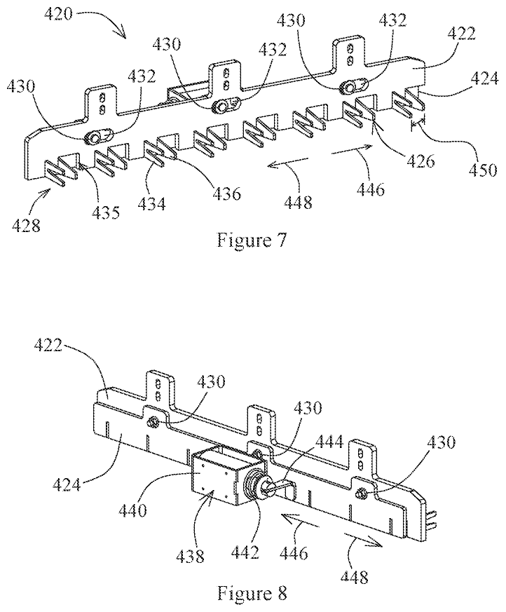

In an embodiment, and as shown in FIGS. 5 and 7, each of the first forks 434 are divided into a pair of fingers. As shown, the fingers could be formed into a “v” shape. However, the fingers could be formed into any shape as appropriate. This design advantageously uses a three-point touch to provide a strong grip to a sapling 518 in efficient way.

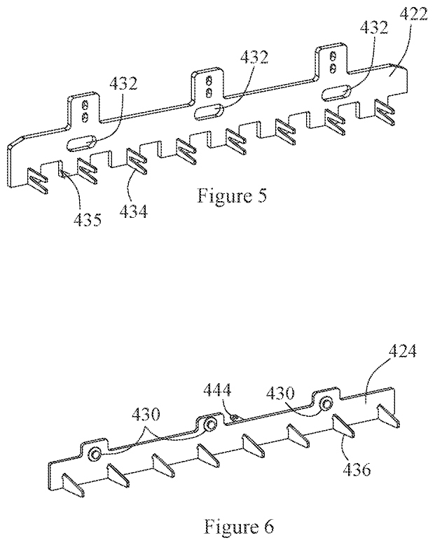

A sliding frame 424 is illustrated in FIG. 6. The sliding frame 424 comprises a plurality of fasteners 430, a plurality of second forks 436, and a drive bracket 444 (shown in FIG. 8) to operatively coupled to the actuation mechanism 438. It is contemplated that instead of the first forks 434 split into pair or forks as shown in FIG. 7, the second forks 436 could be split into a pair of forks.

FIG. 7 illustrates a complete sapling gripping head 420 from forward direction 103 and in closed condition. As shown, the support frame 422 and the sliding frame 424 are slidably connected through the fasteners 430 and the holes 432. The length of holes 432 defines the maximum ply of the sliding frame 424 with respect the support frame 422. Each of the second forks 436 from the sliding frame 424 fits in each of the slots 435 and aligns with respective first fork 434 besides the respective slot of the support frame 422 forming one gripping unit 426. Each of the second forks 436 slide within a slot 435 in directions 446 and 448. This construction advantageously uses optimal number of parts to form a plurality of gripping units 428 and operating the same.

As shown, in an embodiment eight gripping units 426 are arranged on the gripping head 420. FIG. 8 illustrates the sapling gripping head 420 from the rear view. The actuating mechanism 438 is coupled to the drive bracket 444 to slide the sliding frame 424 with respect to the support frame 422 in linear directions 446 and 448. In an embodiment, the actuating mechanism 438 is a linear actuator and more specifically an electric solenoid plunger. A biasing member in the form of a spring 442 acts against the force of the actuating mechanism 438 and pushes the sliding frame in direction of 448 by default achieving a closed condition.

In an embodiment, as shown in FIG. 7, the biasing member 442 pushes the sliding frame 424 in direction 448 and the displacement is limited by the ply of the second fork 436 inside the slot 435. As shown, at a default and non-activated position of the actuating mechanism 438, the second fork 436 touches the left most side of the slot 435 and form a minimum gap 450 between the first and second forks 434, 436 forming a closed condition.

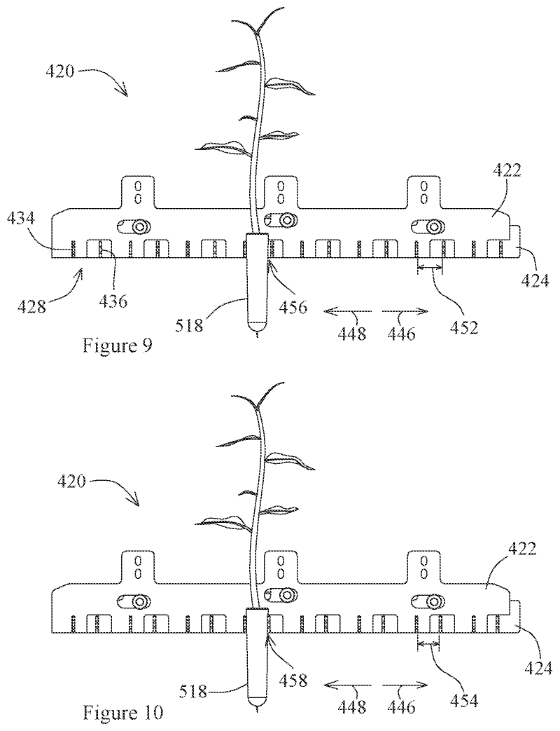

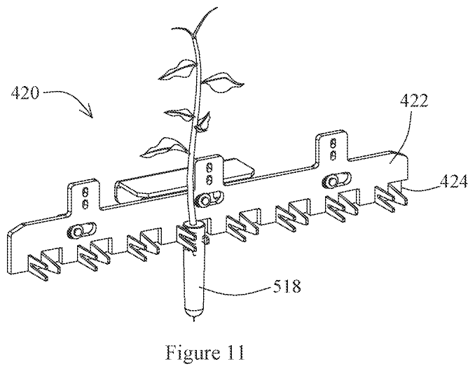

FIGS. 9 and 10 illustrate the working cycle of the gripping head 420. In another embodiment, as the sapling gripping head 420 moved closer to the row of saplings 518 from the tray 510, the actuating mechanism 438 moves the sliding frame 424 with respect to the support frame 422 in the direction 446 such that the first fork 434 and second forks 436 form an increased gap 452 (open condition). The gap 452 is dimensioned such that a tolerance gap 456 is formed between the sapling 518 and the pair of the forks 434, 436 on either side of the sapling 518. This tolerance gap 456 allows easy pickup of the saplings 518 and without any damage to the sapling 518. Once a sapling 518 fits between the gripping unit 426, the actuating mechanism 438 is de-energized the sliding frame moves in direction 448 under the influence of the spring 442. Thus, the second fork 436 of the gripping unit 426, moves in direction 448 and press the sapling 518 against the first fork 434 of the gripping unit 426 as shown at 458 (closed condition).

As the sapling 518 is gripped within the gripping unit 426, the sapling retrieval apparatus 400 moves the gripping head to a position close to the sapling indexing system 700. At this stage, the solenoid plunger 428 moves the sliding frame in direction 446 creating gap between the sapling and the second fork as shown in FIG. 9 (open condition). Due to this, the sapling 518 drops into the sapling indexing system 700. Once the sapling drops, the sliding frame 424 comes the default position (closed condition) under influence of the spring member 442 and the cycle discussed so far repeats.

FIG. 11 illustrates the sapling gripping head 420 in perspective with sapling 518 is gripped between the first fork 434 and the second fork 436 of the gripping head 420. It is understood that the gripping head 420 may hold saplings 518 less that the number of total capacity.

In an embodiment, enough care shall be taken to maintain all saplings 518 in a row to have equal thickness to be efficiently gripped by the gripping units 428 as the gap 454 is defined by the largest sapling by thickness. It is contemplated that the saplings 518 come in slightly different sizes of thickness. To accommodate different sizes of saplings 518, a buffer (not shown) is placed between the sliding frame 424 and each of the second forks 436. The buffer could be a spring and allow to accommodate various sizes of the saplings 518 without losing the gripping power within the gripping head 420.

In a further embodiment, the actuators are linear actuators and may be selected from but not limited to hydraulic actuators, electric actuators and pneumatic actuators. However, any other kind of actuators can be used to drive the trays 510.

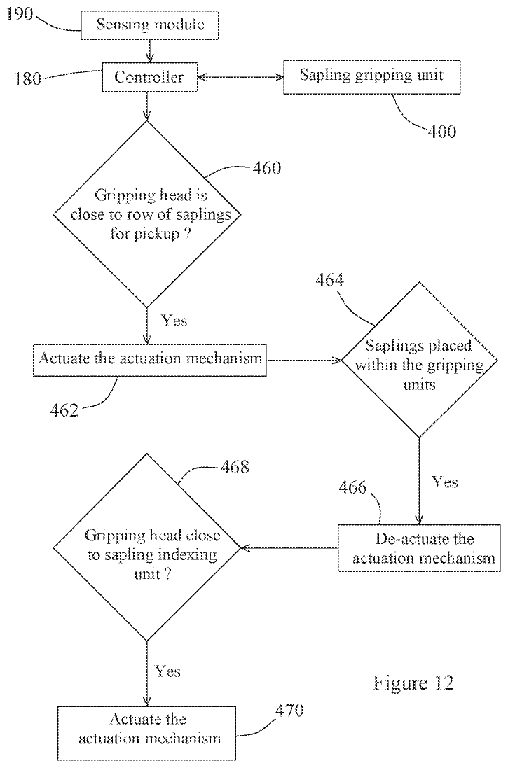

As shown, the gripping head 420 works in sync with the sapling retrieval apparatus 400. FIG. 12 illustrates the flow of events in the operating of the gripping head 420. The controller 180 receives inputs from the sensor module 190 and operates the sapling retrieval apparatus 400 and at the same time, tracks the position of the gripping head 420. At step 460, the controller 180 checks the position of the gripping head 420 with respect to the row of the saplings 520 from the sapling tray 510. As the gripping head 420 is closer to the row of saplings 520. At step 462, the controller 180 actuates the actuation mechanism 438 to create maximum gap in gripping units 426 changing the gripping head 420 to open condition. The gripping head 420 is moved towards the row of saplings 520, and at step 464, the controller 180 determines if the saplings 518 are placed within the gap of the gripping units 426. At step 466, the controller 180 deactivates the actuating mechanism 438 allowing the biasing member 442 to change the gripping units 426 to a closed condition where the gripping units 426 hold the saplings 518. At step 468, the controller 180 operates the sapling retrieval unit 400 to bring the gripping head 420 and once confirmed, actuates the actuation mechanism 438 again to bring the gripping units 426 to the open condition allowing free fall of the sapling 518 from the gripping head 420 to the indexing system 700.

Various features are set forth in the following claims.

What is claimed is:

1. A sapling gripping head for a transplanter comprising:
a support frame;
a sliding frame slidably coupled to the support frame;
a plurality of gripping units comprising a first fork coupled to the support frame and a second fork coupled to the sliding frame; and
an actuation mechanism configured to slide the sliding frame relative to the support frame.

2. The sapling gripping head of claim 1, wherein the actuation mechanism comprises a linear actuator.

3. The sapling gripping head of claim 1, wherein the actuation mechanism further comprises a biasing member biasing the sliding frame against the support frame and the actuation mechanism slides the sliding frame against the force of the biasing member.

4. The sapling gripping head of claim 1, wherein the first fork further comprises a pair of fingers.

5. The sapling gripping head of claim 4, wherein the pair of fingers forms a ‘v’ shape.

6. The sapling gripping head of claim 1, wherein the first fork is normal to the support frame and the second fork is normal to the sliding frame.

7. The sapling gripping head of claim 1, wherein the support frame further comprises a slot proximal to the first fork and the second fork moves within the slot.

8. The sapling gripping head of claim 1, further comprising a gap defined between the first fork and the second fork, the gap is configured to hold a sapling.

9. The sapling gripping head of claim 1, wherein the number of gripping units are equal to the number of saplings in a row of a sapling tray arranged on the transplanter.

10. The sapling gripping head of claim 1, further comprising a sapling retrieval apparatus coupled to the sapling gripping head.

11. The sapling gripping head of claim 10, wherein the sapling retrieval apparatus controls a position of the sapling gripping head relative to the sapling tray.

12. The sapling gripping head of claim 11, wherein the position of the sapling gripping head is selected from a sapling pick position, a sapling drop position, and a rest position.

13. The sapling gripping head of claim 1, wherein the second fork further comprises a biasing member placed between the second fork and the sliding frame.

14. The sapling gripping head of claim 1, wherein the actuation mechanism is a linear solenoid actuator.

15. The sapling gripping head of claim 1, further comprising a controller configured to regulate the actuation mechanism.
